(19) United States
(12) Patent Application Publication
(10) Pub. No.: US 2024/0059908 A1
(43) Pub. Date: Feb. 22, 2024

(54) Surface Coating Composition

(71) Applicant: Repela Tech LLC, Plymouth, MI (US)

(72) Inventors: Stephen A. Fischer, Northville, MI (US); Sheu-Jane Gallagher, Detroit, MI (US); Edward S. Kim, West Bloomfield, MI (US); Jennifer Rigney, Dearborn, MI (US)

(21) Appl. No.: 18/234,971

(22) Filed: Aug. 17, 2023

Related U.S. Application Data
(60) Provisional application No. 63/399,699, filed on Aug. 21, 2022.

(51) Int. Cl. C09D 5/16; C09D 5/00; C09D 133/26; C09D 163/00; C09D 7/45

(52) U.S. Cl. CPC C09D 5/1668; C09D 5/002; C09D 133/26; C09D 163/00; C09D 7/45

(57) ABSTRACT

A coating composition with improved adhesion to a hydrophobic paint primer substrate consisting of a waterborne zwitterionic copolymer coating composition that is biocide-free and zero volatile organic compounds that improves the environmental and sustainability issues of today's toxic marine antifouling coatings.

### CROSS-REFERENCE TO RELATED APPLICATIONS

The present invention claims priority to U.S. Prov. Pat. App. No. 63/399,699, titled “Surface Coating Composition,” filed Aug. 21, 2022, which is incorporated herein by reference in its entirety.

### TECHNICAL FIELD OF INVENTION

The present invention relates to a biocide-free, zero volatile organic (VOC) antifouling hydrophilic polymeric surface coating compositions for marine applications. Specifically, the present invention relates to antifouling waterborne zwitterionic copolymer coating compositions that are biocide-free and VOC-free and that adhere to a paint primed surface. Whereas, the waterborne zwitterionic copolymer coating compositions are applied over a paint primer modified with a multi-functional epoxy additive, the waterborne zwitterionic copolymer coating compositions adhere to the paint primer and provide excellent antifouling properties below the waterline on the hull of a vessel or any substrate that is immersed in a fresh and/or saltwater environment.

### BACKGROUND OF THE INVENTION

Structures that are immersed in water are prone to fouling by aquatic organisms such as algae, barnacles, mussels, and the like, a condition known as biofouling. This creates drag on ships, which increases fuel consumption and adds to maintenance costs as periodic cleaning of the ship's hull is required. In addition to the cost penalty to ship owners and operators, there are also significant consequences to the environment. Because of increased fuel usage, biofouling adds hundreds of metric tons of CO₂ emissions to the atmosphere each year. Biofouling is also the main contributor to invasive species transfer.

To combat this issue, commercial ship owners and operators, military fleets, and recreational boat owners regularly apply antifoulant paint, a special category of marine paints and coatings to vessel hulls to control marine organism attachment. The products currently in use achieve their antifouling action by using toxic biocides and biocidal pigments to harm or kill the organisms. For example, common marine coating products, such as Self-Polishing Coatings (SPC) and Fouling-Release Coatings (FRC), contain copper, biocides, and volatile organic compounds (VOC). These chemicals may find their way into the environment through leaching.

For decades, some commercial antifoulant paints contained tributyltin (TBT), a metal-based biocide introduced by the marine paint industry in the late 1960s. These antifoulant paints gradually release TBT into the water to kill the organisms in close proximity to the hull before they have a chance to attach and proliferate. Unfortunately, TBT proved to be highly toxic for many aquatic organisms, well beyond the greater than 4000 species responsible for biofouling, and its prolonged utilization has caused severe damage to aquatic life.

The International Maritime Organization (IMO), the United Nations agency responsible for shipping safety, security, and marine pollution, has imposed an international ban on the use of tributyl tin (TBT) in antifoulant paints (IMO Convention on the Control of Harmful Anti-fouling Systems on Ships). The convention was adopted in 2001 and came into full force in 2008. Paint manufacturers ceased production of TBT antifoulant paints even before the ban came into effect and developed TBT replacements containing alternative biocides such as cuprous oxide, copper thiocyanate, and coated copper flakes. Today, copper-based antifoulant paints represent 95% of the global market.

Even though they are less harmful than TBT, recent environmental studies have shown that copper released by antifoulant paints are accumulating in harbors and marinas to concentrations exceeding acceptable water quality levels as defined by the Clean Water Act. Because of these events, California's Department of Pesticide Registration, in 2018, imposed a limit on the copper leach rate of 9.5 μg/cm²/day on antifoulant paints used on recreational vessels. Essentially, any antifoulant paint having a higher leach rate is prohibited from sale in the state. Washington State's Department of Ecology is considering similar leach rate restrictions. The US EPA is reviewing a leach rate restriction, although a timeline for such a restriction has not been publicized.

Globally, all biocide-containing antifoulant paints are subject to regulations that review product quality, performance, and safety. In the United States, any antifoulant paint containing active ingredients must be registered with the Environmental Protection Agency under the Federal Insecticide, Fungicide, and Rodenticide Act (FIFRA). The European Union, in order to harmonize regulations across EU countries, put in place the Biocidal Products Regulation (EU) No. 528/2012 (BPR), which requires all antifouling paints to undergo a new authorization process. The authorization process takes multiple years and is ongoing, but during the process, paint manufacturers are being allowed to continue sales of their products.

Over the past decades, new types of antifouling materials for marine environment have been developed, and range from natural polysaccharides to synthetic polymers, including polyethylene glycol (PEG). The protein resistance of PEG polymers and their oligomers are well known and has been exploited in many applications. Hydrogel coatings (ca. polyethylene glycol, and their derivatives.) are of special interest because they show antifouling performance due to their super-hydrophilicity property that creates a water layer between the vessel hull and the marine animals preventing adhesion. Hydrogels also display a relatively low Young's modulus that destabilize the attachment of marine organisms. However, despite their immense promise, the poor substrate adhesion and low durability greatly hinder their practical application as antifouling marine paints or coatings.

Zwitterionic polymers are a class of materials that contain both cationic and anionic charges on the same functional moiety, with their overall charge being neutral. Compared with PEG materials, zwitterionic polymers have much stronger hydration proper-coats, which is considered a critical factor for creating a barrier and preventing antifouling on marine surfaces. Zwitterionic polymers have been extensively explored as antifouling materials. They inhibit the attachment of many microorganisms, such as algae, barnacles, and mussels. However, waterborne zwitterionic polymers typically show poor adhesion to various substrates. Some approaches have been developed in an attempt to overcome this problem, such as covalently grafting zwitterionic functionality onto hydrophobic binder resins used as marine paints, or incorporation into hydrophobic elastomeric polymer networks, however, the resulting coated surfaces with zwitterionic moieties require biocides to augment antifouling properties in a marine environment.

A need, therefore, exists for improved surface coating compositions for use in marine applications. Specifically, a need exists for improved surface coating compositions using zwitterionic polymer compositions. More specifically, a need exists for improved surface coating compositions that provide improved antifouling properties in marine applications.

In addition, there exists a need to improve the adhesion of a surface coating composition having a waterborne zwitterionic polymer coated over a hydrophobic painted surface. Moreover, there is a need for improved surface coating compositions that are biocide-free. In addition, a need exists for improved surface coating compositions that do not contain VOC. Further, there is a need for improved surface coating compositions that overcome the environmental and sustainability issues of today's toxic marine antifouling coatings.

### SUMMARY OF THE INVENTION

In view of the above-mentioned need, the present inventors have developed an antifouling waterborne zwitterionic copolymer coating composition that is biocide-free and VOC-free that adheres to a paint primed surface. Whereas, the waterborne zwitterionic copolymer coating composition is applied over a paint primer modified with a multi-functional epoxy additive, the waterborne zwitterionic copolymer coating composition adheres to the paint primer and provides excellent antifouling properties below the waterline on the hull of a vessel or any substrate that is immersed in a fresh and saltwater environment.

The waterborne zwitterionic copolymer composition contains a wetting agent to improve the flow and leveling of the hydrophilic copolymer over the hydrophobic paint primer modified with a multi-functional epoxy additive.

Optionally, the waterborne zwitterionic copolymer coating composition may contain a humectant to control the drying rate over the hydrophobic paint primer.

Moreover, the waterborne zwitterionic copolymer composition of the present invention, optionally contains a multi-functional epoxy additive that is blended into the copolymer solution prior to coating over a paint primer modified with a multi-functional epoxy additive to enhance the mechanical integrity of the polymer film.

Other aspects of this invention relates to improving the hardness of the waterborne zwitterionic copolymer coating by crosslinking the said waterborne zwitterionic copolymer coating with a divinyl monomer incorporated into the monomer mix prior to polymerization to produce the waterborne zwitterionic copolymer composition.

Not being bound by theory, the present inventors hypothesize that the addition of a multi-functional epoxy additive in the paint primer augments covalent bonding between the waterborne zwitterionic copolymer coating composition and the paint primer undercoat further enabling the waterborne zwitterionic copolymer coating composition to adhere to the undercoat substrate in fresh and saltwater environments.

When introducing elements of various embodiments of the disclosed materials, the articles “a,” “an,” “the,” and “said” are intended to mean that there are one or more of the elements. The terms “comprising,” “including,” and “having” are intended to be inclusive and mean that there may be additional elements other than the listed elements. Furthermore, any numerical examples in the following discussion are intended to be non-limiting, and thus additional numerical values, ranges, and percentages are within the scope of the disclosed embodiments.

### DESCRIPTION OF THE DRAWINGS

The foregoing aspects and many of the associated advantages of this invention will become more readily appreciated as the same become better understood by reference to the following detailed description, when taken in conjunction with the accompanying drawings, wherein:

FIG. 1 illustrates the invention as a marine coating composition over a substrate, wherein a waterborne zwitterionic copolymer coating composition is applied over a partially cured modified two-component epoxy paint primer containing a multi-functional epoxy additive that has been previously coated over unmodified paint primer layers.

FIG. 2 illustrates the structure of polyethylene glycol diglycidyl ether, where n is an integer between 200 and 1000.

FIG. 3 is a graph showing the refractive index as a function of ethylene glycol diglycidyl ether in the epoxy resin part of a two-component epoxy paint primer.

FIG. 4A is a reference NMR scan of carboxybetaine methacrylamide monomer.

FIG. 4B is an NMR scan of carboxybetaine methacrylamide monomer prepared in Experiment 1.

FIG. 5A is a picture of the antifouling marine coating composition after 5-months static immersion in a FL inter-coastal waterway.

FIG. 5B is a picture of the antifouling marine coating composition after 8-months static immersion in a FL inter-coastal waterway.

### DETAILED DISCLOSURE OF THE INVENTION

The present invention relates to a biocide-free, zero volatile organic (VOC) antifouling hydrophilic polymeric surface coating compositions for marine applications. Specifically, the present invention relates to antifouling waterborne zwitterionic copolymer coating compositions that are biocide-free and VOC-free and that adhere to a paint primed surface. Whereas, the waterborne zwitterionic copolymer coating compositions are applied over a paint primer modified with a multi-functional epoxy additive, the waterborne zwitterionic copolymer coating compositions adhere to the paint primer and provide excellent antifouling properties below the waterline on the hull of a vessel or any substrate that is immersed in a fresh and/or saltwater environment.

Except in examples, or where otherwise expressly indicated, all numerical quantities in this description used to indicate amounts of material or dimensions are to be understood as modified by the word “about” or similar terminology in describing the broadest scope of the invention.

The antifouling waterborne zwitterionic copolymer coating composition is formed by applying a partially cured paint primer that includes a multi-functional epoxy additive, on a paint primed substrate, and allowing the coating to completely cure at ambient temperature and humidity conditions. Optionally, a multi-functional epoxy additive is mixed into the waterborne zwitterionic copolymer coating composition prior to applying the copolymer composition to the partially cured paint primer that contains a multi-functional epoxy additive. and further allowing the coating composition to completely cure at ambient environmental conditions.

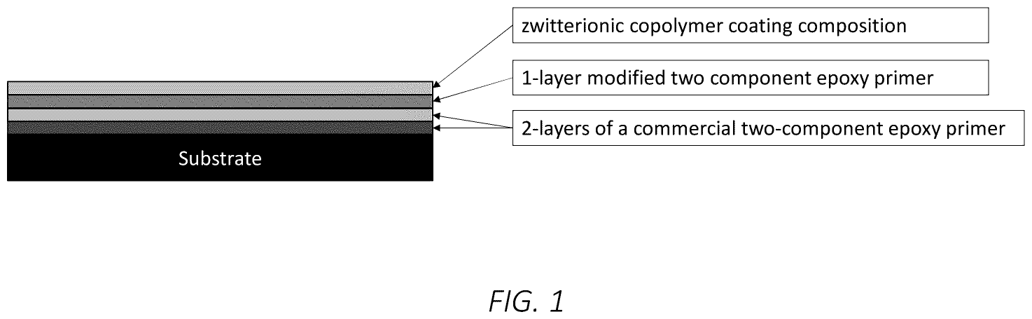

FIG. 1 depicts exemplary embodiments of the present invention, where the waterborne zwitterionic copolymer coating composition may be applied over one-layer of a modified paint primer that contains a multi-functional epoxy additive and two-layers of paint primer. The two-layers of paint primer may be applied to a clean surface followed by applying a modified paint primer containing a multi-functional epoxy additive to achieve a total dry film thickness (“DFT”) of about 6 to about 15 mils. Preferably, the primer paint layers may be about 6 to about 8 mils DFT. The waterborne zwitterionic copolymer coating composition may be applied at about 1 to about 3 mils DFT over the partially cured multi-functional epoxy additive. Preferably the waterborne zwitterionic copolymer coating composition is about 1 to about 2 mils DFT.

The antifouling waterborne zwitterionic copolymer coating composition of the present invention generally comprises; (i) a waterborne zwitterionic copolymer comprising zwitterionic monomers from Group A (as defined hereinbelow) at about 25 to about 90% by weight, anionic monomers from Group B (as defined hereinbelow) at about 5 to about 70% by weight, reactive monomers from Group C (as defined hereinbelow) at about 2 to about 50% by weight, (ii) a paint primer that contains a multi-functional epoxy additive from about 5 to about 15% by weight and; (iii) wherein the partially cured two-component epoxy paint primer containing a multi-functional epoxy additive is applied to a paint primer over a substrate. The coated surface is further allowed to cure at ambient temperature and humidity conditions.

### Waterborne Zwitterionic Copolymer

The waterborne zwitterionic copolymer, as defined above may be prepared by conventional solution polymerization methods by dissolving the monomers in water, adding a free radical initiator, and heating to form a copolymer solution.

The copolymers of the present invention may be synthesized by free radical polymerization or thermal polymerization. Preferably, the copolymers are synthesized using free radical polymerization.

As is known in the art, free radical polymerization requires a source of free radicals to initiate the polymerization. A source of initiating radicals can be provided by any suitable means, such as the thermal induction of free radical initiators, redox initiating systems, photochemical initiating systems or by high energy radiation such as electron beam.

Redox initiator systems are generally chosen to have an appropriate rate of radical flux under the conditions of the polymerization. These initiating systems can include, but are not limited to, combinations of the oxidants potassium-, ammonium-, sodium-peroxydisulphate, sodium thiosulphate, potassium thiosulphate, sodium bisulphite or potassium bisulphite. It is also envisaged that mixtures of free radical initiators may be used and, in particular, the combination of peroxydisulphate compounds with suitable redox systems, such as bisulphite, isoascorbic acid or tetramethyl ethylenediamine.

The amount of free radical initiator added to the monomer mixture will generally be in the range from about 0.2 to about 3.0% by weight based on monomer concentration, and preferably from about 0.4 to about 2.0% by weight based on monomer concentration. Following a standard practice in the art, a supplementary amount of initiator, called a chaser, may optionally be added at the end of the polymerization process to assist in the conversion of any residual monomers. The chaser initiator is typically added at about 0.1 to about 0.5% by weight based on the initial monomer concentration.

The polymerization may be conducted at atmospheric pressure, elevated pressure or reduced pressure as is known in the art. Further, whilst the polymerization temperature is not particularly limited, and may be adjusted depending on the half-life of the polymerization initiator(s) used, it should preferably be from 25° C. to 80° C., more preferably from 30° C. to 80° C. under atmospheric pressure.

Similarly, whilst the polymerization time is not particularly limited, it is preferred to continue the polymerization until the monomer conversion level is less than about 0.5% by weight is reached. As such, the polymerization time will generally be from about 2 hours to about 6 hours.

Further, whilst the atmosphere is not particularly limited, the polymerization may be conducted in air or alternatively, may be conducted under an inert gas stream, such as a nitrogen stream, which may eliminate oxygen to provides an atmosphere that is more efficient for free radicals to react with monomer.

The waterborne zwitterionic copolymer of the present invention may optionally contain additives, that may be introduced after the polymerization. Such additives include pigments, dyes, emulsifiers, surfactants, thickeners, heat stabilizers, wetting agents, anti-cratering agents, fillers, sedimentation inhibitors, UV absorbers, antioxidants, waxes, antifoaming agents, humectants, and the like.

Particularly useful is a wetting agent added to the waterborne zwitterionic copolymer at levels below about 5% by weight, preferably at about 1% by weight. A wetting agent is a surface-active material that reduces the surface tension of water enabling the hydrophilic waterborne zwitterionic copolymer to spread smoothly over a hydrophobic surface, such as the modified paint primer. Useful wetting agents may include polyether-modified polydimethylsiloxane and are marketed by BYK®.

Another useful additive that may be mixed into the waterborne zwitterionic copolymer to aid proper drying over the paint primer is a humectant. Humectants are hygroscopic substances that promote the retention of moisture in the waterborne zwitterionic copolymer as it dries over the modified paint primer. The humectant is particularly advantageous when applying the waterborne zwitterionic coating when the humidity is less than about 40% by weight. Humectants, such as, for example, propylene glycol, glycerol, and the like, are useful when added to the waterborne zwitterionic copolymer at levels less than about 5% by weight, preferably at about 1% by weight.

In preferred embodiments, the waterborne zwitterionic copolymer comprises the solution polymerization of monomers selected from Group A, Group B, Group C and optionally a crosslinking monomer.

The presence of cross-linking in the waterborne zwitterionic copolymer is optional by the present invention. In certain exemplary embodiments, the copolymers of the present invention can be manufactured free of crosslinking, as such, the waterborne zwitterionic copolymers have sufficient mechanical strength that crosslinking is not necessary for making a polymer coating suitable for use as a fouling resistant coating. The absence of cross-linking may serve to give these copolymers improved elasticity, particularly when dry, which may reduce the likelihood of cracking on curing of the waterborne zwitterionic copolymer coating over the partially cured modified epoxy paint primer with a multi-functional epoxy additive. In other exemplary embodiments, cross-linking the waterborne zwitterionic copolymer can harden the surface when dry, as such, improving the abrasion resistance of the coating.

### Monomers

According to the aspects of the present disclosure, Group A zwitterionic monomers may be selected from the series consisting of one or more of: a sulfobetaine acrylate, a sulfobetaine methacrylate, a sulfobetaine acrylamide, a sulfobetaine methacrylamide, a vinyl sulfobetaine, a carboxybetaine acrylate, a carboxybetaine methacrylate, a carboxybetaine acrylamide, a carboxybetaine methacrylamide, a vinyl carboxybetaine, a phosphobetaine, a phosphobetaine methacrylate, a phosphobetaine acrylamide, a phosphobetaine methacrylamide, a vinyl phosphobetaine, or a derivative of one or more of the foregoing. Zwitterionic monomers are often assembled by a complex multi-step synthesis. Incorporated by reference in their entireties, the following references outline the pathways of zwitterionic monomer synthesis: Lowe, et. al., Synthesis and Solution Properties of Zwitterionic Polymers, Chem Rev. 2002 102, 4177-4189, and in U.S. Pat. No. 4,012,437, (Shachat, et. al.). Group A monomers may provide antifouling properties and may comprise about 25 to about 90% by weight of the copolymer. Preferably Group A monomers comprise about 40 to about 70% by weight, and most preferably from about 50 to about 62% by weight of the copolymer. The preferred monomer from Group A is carboxybetaine methacrylamide, although the present invention should not be limited as described herein.

According to the aspects of the present disclosure, Group B anionic monomers may be selected from a series consisting of one or more of: 2-Methyl-2-propene-1-sulfonic acid sodium salt, sodium 4-vinylbenzenesulfonate, 2-propene-1-sulfonic acid, sodium acrylate, ammonium acrylate, potassium acrylate, sodium 4-vinylbenzoic acid, γ,γ-Dimethylallyl phosphate ammonium salt, diethyl allyl phosphate, acrylic acid, methacrylic acid, beta-carboxyethyl acrylate, or a derivative of one or more of the foregoing. Group B monomers may provide film hardness properties and may comprise about 5 to about 70% by weight of the copolymer. Preferably Group B monomers comprise about 10 to about 50% by weight, and most preferably from about 18 to about 40% by weight of the copolymer. The preferred monomer from Group B is acrylic acid, although it should be noted that the present invention should not be limited as described herein.

According to aspects of the present disclosure, Group C reactive monomers may be selected from a series consisting of one or more of: vinyl alcohol, N-hydroxyethyl acrylamide, 2-hydroxypropyl acrylate, 4-hydroxybutyl acrylate, hydroxyethyl acrylate, hydroxyethyl methacrylate, hydroxypropyl methacrylate, glycerol methacrylate, hydroxyethyl methacrylate, hydroxyethyl acrylate, 3-phenyl-2-hydroxypropyl methacrylate, N-(2-hydroxypropyl) methacrylamide, poly(ethylene glycol) methacrylate, hydroxypolyethoxy allyl ether, methacryloyl-L-lysine, dimethylaminopropyl acrylamide, dimethylaminoethyl acrylamide, dimethylaminopropyl methacrylamide, dimethylaminoethyl methacrylamide, 2-(tert-butylamino) ethyl methacrylate, vinyl amine or a derivative of one or more of the foregoing. Group C monomers comprise about 2 to about 50% by weight of the copolymer. Group C monomers may provide reactive moieties that may anchor the waterborne zwitterionic copolymer by covalently bonding to the surface of the partially cured modified paint primer containing a multi-functional epoxy additive. The Group C monomers may be selected solely based on hydroxy or amine functionality, or in any combination of the two reactive functionalities. Preferably Group C monomers may comprise about 10 to about 30% by weight, and most preferably from about 10 to about 20% by weight of the copolymer. The preferred monomers from Group C are hydroxyethyl methacrylate and dimethylaminopropyl methacrylamide, although it should be noted that the present invention should not be limited as described herein.

A crosslinking monomer is optionally added at less than about 5.0% by weight, based on the sum of the weight of the monomers selected from the forgoing Groups of monomers in A, B, C. The crosslinking monomer may increase the waterborne zwitterionic copolymer film hardness. According to aspects of the present disclosure, a reactive crosslinking monomer may be selected from a group consisting of an acryloyl-containing crosslinker, an allyl crosslinker, and a vinyl crosslinker. A useful crosslinking monomer is methylene bis-acrylamide.

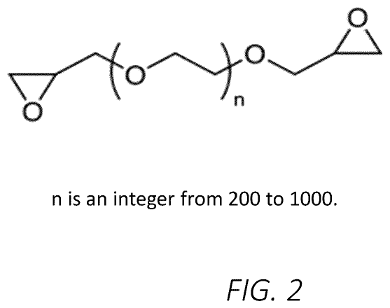

Optionally, a multi-functional epoxy additive can be mixed into the waterborne zwitterionic copolymer prior to coating over the partially cured modified epoxy paint primer containing a multi-functional epoxy additive to improve the hardness and durability of the waterborne zwitterionic copolymer film in an underwater marine environment. Examples are, but are not limited to, ethylene glycol diglycidyl ether, polyethylene glycol diglycidyl ether having a molecular weight of from about 200 to about 1000 (FIG. 2), trimethylolpropane diglycidyl ether. Preferably, the multi-functional epoxy additive comprises about 0.5 to about 5% by weight of the waterborne zwitterionic copolymer, and most preferably from about 1 to about 3% by weight of the waterborne zwitterionic copolymer. The preferred multi-functional epoxy additive is ethylene glycol diglycidyl ether.

The present invention may utilize a tie-coat that acts as a nexus between a primer and a finished top coat. A tie-coat may provide a transitional layer that may improve the adhesion between two separate coatings. Not being limited, an example of a tie-coat that may be useful in the present invention may be a linear or branched polyamine containing primary, secondary, and optionally tertiary amine functionality. Examples of such are alkylated polyamines, alkylated phenolic polyamines, polyethyleneimines. Polyethyleneimines marketed by BASF® under the trade name Lupasol™ may be particularly useful as a tie-coat to promote adhesion between the paint primer and the waterborne zwitterionic copolymer coating composition. Polyethyleneimines are multi-functional branched cationic polymers. The nitrogen to carbon ratio in polyethyleneimines is 1:2, so that they have a large amino group density. The composition is expressed by the formula —(CH₂—CH₂—NH)ₙ— where n is less than 10⁵. A useful tie-coat may be Lupasol-P™ having a molar mass of 750,000 and a cationic charge density of 17 meq/g.

### Paint Primer

Conventional commercial paint primers may be used under the waterborne zwitterionic copolymer coating composition. Common paint primer coatings are polyester, vinyl ester and epoxy that may be used below the waterline in marine applications. Polyester is easy to use and cures quickly, but it is physically weak and brittle and has poor adhesive properties. Vinyl ester has better strength and moisture resistance than polyester, cures quickly, but is still physically weak and brittle, and has modest adhesive properties. Of particular use with the waterborne zwitterionic copolymer coating compositions of the present invention may be epoxy-based technology that has become the mainstay for paint primers and topcoats in the marine marketplace. Epoxies are slower curing, as compared to polyester and vinyl ester, but they have much higher strength and toughness, excellent adhesion, a ‘fixed’ cure system with no un-reacted components or additives, and, most importantly, epoxies are not attacked by water. Typically, marine epoxy paint primers come in two parts. Part 1 is the epoxy resin, usually dissolved in solvent, and Part 2 is the hardener, which is typically pigmented. The most widely commercialized epoxy resins are based on the reaction product of epichlorohydrin and bisphenol A diglycidyl ether. The hardener chemistry is based on polyfunctional polyamines. On application, the two components are mixed at a desired volume ratio and cured at ambient temperatures to a hard-dry hydrophobic coating.

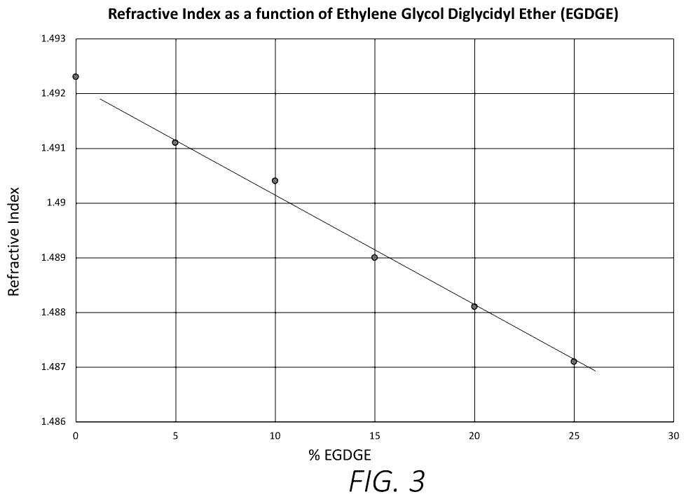

To a conventional paint primer may be added a multi-functional epoxy additive at about 5 to about 15% by weight of the paint primer. Examples of multi-functional epoxy compounds are trimethylolpropane triglycidyl ether, Ethylene glycol diglycidyl ether, neopentyl glycol diglycidyl ether, Triglycidyl glycerol ether, Resorcinol diglycidyl ether, polyethylene glycol diglycidyl ether, bis(2,3-epoxypropyl ether, 1,4-butanol diglycidyl ether, 2,6-diglycidyl phenyl ether, triethylene glycol diglycidyl ether, 3,4-Epoxy-6-methylcyclohexenecarboxylic acid (3,4-epoxy-6-methylcyclohexylmethyl) ester, or a derivative of one or more of the foregoing. The addition of a multi-functional epoxy additive may have no deleterious effects on the paint primer properties. The preferred multi-functional epoxy additive may be ethylene glycol diglycidyl ether. FIG. 3 is a graph showing the refractive index as a function of ethylene glycol diglycidyl ether in an epoxy resin component of a two-part epoxy paint primer.

Whilst not particularly limited, one commercial paint primer specifically used in underwater applications, Interlux VC Performance Epoxy®, when modified with a multi-functional epoxy additive at about 5 to about 15% by weight, provides excellent adhesion to the waterborne zwitterionic copolymer coating composition. Interlux® VC Performance Epoxy™ is a two-component epoxy that cures to a hard-slick finish ideal for underwater surfaces. VC Performance Epoxy™ is supplied in two-parts, an epoxy resin in solvent and a pigmented hardener dispersed in solvent. VC Performance Epoxy™ has no antifouling or foul release properties. Another commercial paint primer useful, when modified with a multi-functional epoxy additive at about 5 to about 15% by weight, provides excellent adhesion to the Waterborne zwitterionic copolymer coating composition. Interprotect® 2000E is marketed by Akzo Nobel as a universal paint primer used for corrosion protection on all underwater metals for hulls, keels, trim tabs and running gear.

### EXAMPLES

Examples of waterborne zwitterionic copolymer coating compositions and modified two-component epoxy paint primers according to the present invention are subsequently disclosed in Table 1 and Table 2. Table 1 shows a summary of the examples of the waterborne zwitterionic copolymer compositions and physical properties of this invention. Table 2 shows examples of the present invention's modified two-component epoxy paint primer containing a multi-functional epoxy additive.

The processes described as examples are not intended to be limiting. Other processes, including the compositions, concentrations, materials, and the like used therein that do not fall within the example but that are in accordance with the above description are part of the present invention.

TABLE 1
Zwitterionic Copolymer Compositions

| | | | | Dimethylamino | | | |
|---|---|---|---|---|---|---|---|
| | | Acrylic | Hydroxyethyl | ethyl | | | |
| Copolymer | Zwitterionic | Acid | methacrylate | methacrylate | Viscosity | | Polymer |
| Examples | (%) | (%) | (%) | (%) | (cps) | pH | (%) |
| Comparative | 77 | 23 | — | — | 126 | 7.2 | 20 |
| 1 | 62 | 18 | 20 | — | 438 | 6.7 | 20 |
| 2 | 62 | 18 | 20 | — | 452 | 6.8 | 20 |
| 3 | 50 | 40 | 10 | — | 617 | 7.0 | 20 |
| 4 | 50 | 40 | 10 | — | 587 | 6.9 | 20 |
| 5ª | 50 | 40 | 10 | — | 83 | 7.2 | 10 |
| 6 | 62 | 18 | — | 20 | 139 | 7.2 | 20 |

ªContains 3% methylene bis-acrylamide

TABLE 2
Modified Two-Component Epoxy Primer Compositions

| | | | | Ethylene Glycol |
|---|---|---|---|---|
| | Epoxy | Epoxy | Ethylene Glycol | Diglycidyl Ether |
| | base | hardener | Diglycidyl Ether | added to Epoxy |
| Examples | (g) | (g) | (g) | Paint (%) |
| Comparative | 8.9 | 6.1 | — | 0 |
| 7A | 8.9 | 6.1 | 0.75 | 5 |
| 7B | 8.9 | 6.1 | 1.5 | 10 |
| 7C | 8.9 | 6.1 | 2.25 | 15 |

### Example 1—Preparation of Waterborne Zwitterionic Copolymer

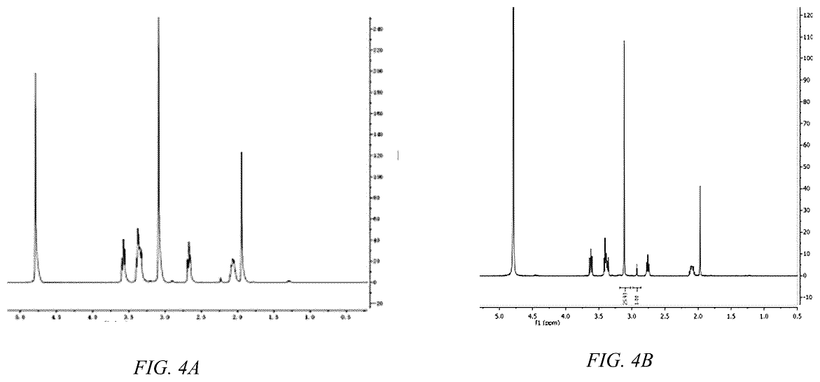

To a round bottom reaction flask equipped with a stirrer, addition ports and a temperature controller, were added 63.9 g dimethylaminopropyl methacrylamide (54.3% in water) and 67.1 g D.I. H₂O. Under mixing, 29.5 g of acrylic acid was slowly added keeping the exotherm below 30° C. After the addition of acrylic acid, the monomer solution was heated to 60° C. and held for about 6 hours. The monomer solution was cooled to 25° C. and held overnight. An NMR scan confirmed the formation of the CBMAA monomer. The reference scan of CBMAA is compared to the synthesis scan in FIGS. 4A and 4B, which shows 400 MHz ¹H NMR spectrum of carboxybetaine methacrylamide (CBMAA), where FIG. 4A is a reference ¹H NMR spectrum for CBMAA and FIG. 4B is a ¹H NMR scan of CBMAA synthesized according to Example 1.

Next was added 193.7 g D.I. water and 15.8 g hydroxyethyl methacrylate. Under mixing, the pH was adjusted to 5.9 with 11.3 g of 28% ammonium hydroxide solution while maintaining the temperature at about 30° C. Added to the reactor at 30° C. in the following order were 4.0 g each of 10% solutions of ammonium persulfate, sodium bisulfite and N,N,N′,N′-tetramethyl ethylenediamine. An immediate exotherm indicated the start of the polymerization reaction. The temperature rose to 36.2° C. in about 30 minutes. The monomer solution was heated to 70° C. and held for about 1 hour. A chaser redox of 1.0 g each of a 10% solution of ammonium persulfate and N,N,N′,N′-tetramethyl ethylenediamine was added. Mixing continued for an additional 60 minutes. 4.0 g BYK-3456™ was added and the waterborne zwitterionic polymer solution was cooled to 25° C. The resulting waterborne zwitterionic polymer solution was a hazy colorless liquid with a pH of 6.7, Brookfield viscosity of 438 cps (spindle #2 @ 30 rpm) and 20% polymer solids.

### Example 2—Preparation of Waterborne Zwitterionic Copolymer

To a round bottom reaction flask equipped with a stirrer, addition ports and a temperature controller, were added 63.9 g dimethylaminopropyl methacrylamide (54.3% in water) and 67.1 g D.I. H₂O. Under mixing, 29.5 g of acrylic acid was slowly added keeping the exotherm below 30° C. After the addition of acrylic acid, the monomer solution was heated to 60° C. and held for about 7.5 hours. The monomer solution was cooled to 25° C. and held overnight.

Next was added 193.7 g D.I. water and 15.8 g hydroxyethyl methacrylate. Under mixing, the pH was adjusted to 5.9 with 11.4 g of 28% ammonium hydroxide solution while maintaining the temperature at about 30° C. Added to the reactor at 30° C. in the following order were 4.0 g each of 10% solutions of ammonium persulfate, sodium bisulfite and N,N,N′,N′-tetramethyl ethylenediamine. An immediate exotherm indicated the start of the polymerization reaction. The temperature rose to 36.0° C. in about 30 minutes. The monomer solution was heated to 70° C. and held for about 1 hour. A chaser redox of 1.0 g each of a 10% solution of ammonium persulfate and N,N,N′,N′-tetramethyl ethylenediamine was added. Mixing continued for an additional 75 minutes. 4.0 g BYK-3456™ was added and the waterborne zwitterionic polymer solution was cooled to 25° C. The resulting waterborne zwitterionic polymer solution was a hazy colorless liquid with a pH of 6.8, Brookfield viscosity of 452 cps (spindle #2 @ 30 rpm) and 20% polymer solids.

### Example 3—Preparation of Waterborne Zwitterionic Copolymer

To a round bottom reaction flask equipped with a stirrer, addition ports and a temperature controller, were added 21.1 g dimethylaminopropyl methacrylamide and 81.0 g D.I. H₂O. Under mixing, 32.9 g of acrylic acid was slowly added keeping the exotherm below 30° C. After the addition of acrylic acid, the monomer solution was heated to 60° C. and held for about 7 hours. The monomer solution was cooled to 25° C. and held overnight.

Next was added 125.4 g D.I. water and 6.0 g hydroxyethyl methacrylate. Under mixing, the pH was adjusted to 6.2 with 19.1 g of 28% ammonium hydroxide solution while maintaining the temperature at about 30° C. Added to the reactor at 30° C. in the following order were 3.0 g each of 10% solutions of ammonium persulfate, sodium bisulfite and N,N,N′,N′-tetramethyl ethylenediamine. An immediate exotherm indicated the start of the polymerization reaction. The temperature rose to 35.6° C. in about 30 minutes. The monomer solution was heated to 70° C. and held for about 1 hour. A chaser redox of 0.6 g each of a 10% solution of ammonium persulfate and N,N,N′,N′-tetramethyl ethylenediamine was added. Mixing continued for an additional 1 hour. 3.0 g BYK-3456™ was added and the waterborne zwitterionic polymer solution was cooled to 25° C. The resulting waterborne zwitterionic polymer solution was a hazy colorless liquid with a pH of 7.0, Brookfield viscosity of 617 cps (spindle #2 @ 12 rpm) and 20% polymer solids.

### Example 4—Preparation of Waterborne Zwitterionic Copolymer

To a round bottom reaction flask equipped with a stirrer, addition ports and a temperature controller, were added 21.1 g dimethylaminopropyl methacrylamide and 81.0 g D.I. H₂O. Under mixing, 32.9 g of acrylic acid was slowly added keeping the exotherm below 30° C. After the addition of acrylic acid, the monomer solution was heated to 60° C. and held for about 7 hours. The monomer solution was cooled to 25° C. and held overnight.

Next was added 125.4 g D.I. water and 6.0 g hydroxyethyl methacrylate. Under mixing, the pH was adjusted to 6.2 with 22.3 g of 28% ammonium hydroxide solution while maintaining the temperature at about 30° C. Added to the reactor at 31° C. in the following order were 3.0 g each of 10% solutions of ammonium persulfate, sodium bisulfite and N,N,N′,N′-tetramethyl ethylenediamine. An immediate exotherm indicated the start of the polymerization reaction. The temperature rose to 37.0° C. in about 30 minutes. The monomer solution was heated to 70° C. and held for about 1 hour. A chaser redox of 0.6 g each of a 10% solution of ammonium persulfate and N,N,N′,N′-tetramethyl ethylenediamine was added. Mixing continued for an additional 2 hours. 3.0 g BYK-3456™ was added and the waterborne zwitterionic polymer solution was cooled to 25° C. The resulting waterborne zwitterionic polymer solution was a hazy colorless liquid with a pH of 6.9, Brookfield viscosity of 587 cps (spindle #2 @ 12 rpm) and 20% polymer solids.

### Example 5—Preparation of Waterborne Zwitterionic Copolymer Containing Methylene Bis-Acrylamide

To a round bottom reaction flask equipped with a stirrer, addition ports and a temperature controller, were added 8.0 g of an 81.5% monomer solution in water containing 77% carboxybetaine methacrylamide and 23% acrylic acid. 74.5 g D.I. H₂O was added and the pH of the monomer solution was adjusted to 6.1 with 3.1 g of 28% ammonium hydroxide solution while maintaining the temperature below 25° C. Added to the reactor at 26.5° C. in the following order were 0.3 g methylene bis-acrylamide, 3.0 g each of 10% solutions of ammonium persulfate, sodium bisulfite and N,N,N′,N′-tetramethyl ethylenediamine. The temperature was raised to 60° C. and held for 1.5 hours. After which, a chaser redox of 0.3 g each of a 10% solution of ammonium persulfate and N,N,N′,N′-tetramethyl ethylenediamine were added. Mixing continued for an additional 30 minutes. 1.0 g BYK-3456™ was added and the waterborne zwitterionic polymer solution was cooled to 25° C. The resulting waterborne zwitterionic polymer solution was a hazy colorless liquid with a pH of 7.2, Brookfield viscosity of 83 cps (spindle #2 @ 60 rpm) and 10% polymer solids.

### Example 6—Preparation of Waterborne Zwitterionic Copolymer

To a round bottom reaction flask equipped with a stirrer, addition ports and a temperature controller, were added 20.9 g of an 81.5% monomer solution in water containing 77% carboxybetaine methacrylamide and 23% acrylic acid. Next, 71.3 g D.I. H₂O and 4.2 g of dimethylaminopropyl methacrylamide were added. The pH of the monomer solution was adjusted to 6.4 with 1.8 g of 28% ammonium hydroxide solution while maintaining the temperature below 25° C. Added to the reactor at 27.5° C. in the following order were 1.0 g each of 10% solutions of ammonium persulfate, sodium bisulfite and N,N,N′,N′-tetramethyl ethylenediamine. The temperature was raised to 60° C. and held for 2 hours. After which, a chaser redox of 0.3 g each of a 10% solution of ammonium persulfate and N,N,N′,N′-tetramethyl ethylenediamine were added. Mixing continued for an additional 60 minutes. 1.0 g BYK-3456™ was added and the waterborne zwitterionic polymer solution was cooled to 25° C. The resulting waterborne zwitterionic polymer solution was a hazy colorless liquid with a pH of 7.2, Brookfield viscosity of 139 cps (spindle #2 @ 60 rpm) and 20% polymer solids.

### Comparative Example—Made without Monomers from Group C

To a round bottom reaction flask equipped with a stirrer, addition ports and a temperature controller were added 60.0 g of an 81.5% monomer solution in water containing 77% carboxybetaine methacrylamide and 23% acrylic acid. 162.7 g D.I. H₂O was added and the pH of the monomer solution was adjusted to 6.5 with 9.4 g of 28% ammonium hydroxide solution while maintaining the temperature below 25° C. Added to the reactor at 26.5° C. in the following order were 2.9 g each of 10% solutions of ammonium persulfate, sodium bisulfite and N,N,N′,N′-tetramethyl ethylenediamine. An immediate exotherm indicated the start of the polymerization reaction. The temperature rose to 32.2° C. in about 40 minutes. The monomer solution was heated to 50° C. and held for about 2 hours. A chaser redox of 0.7 g each of a 10% solution of ammonium persulfate and N,N,N′,N′-tetramethyl ethylenediamine were added. Mixing continued for an additional 2 hours. 2.3 g BYK-3456™ was added and the waterborne zwitterionic polymer solution was cooled to 25° C. The resulting waterborne zwitterionic polymer solution was a hazy colorless liquid with a pH of 7.2, Brookfield viscosity of 126 cps (spindle #2 @ 30 rpm) and 20% polymer solids.

### Examples 7A, 7B, 7C—Preparation of Modified Epoxy Paint Primers

Combined into a small blending container was charged an epoxy resin component from a two-component epoxy paint primer and ethylene glycol diglycidyl ether. The amount of ethylene glycol diglycidyl ether added to the epoxy resin was calculated based on the final combined weight of the epoxy resin component and the hardener when mixed together to form the epoxy paint primer. The combined components of epoxy resin and hardener contained 5% ethylene glycol diglycidyl ether (Example 7A), 10% ethylene glycol diglycidyl ether (Example 7B) and 15% ethylene glycol diglycidyl ether (Example 7C) of Table 2. The modified epoxy paint primer Examples 7A-C of this invention were incorporated as the third layer over two-layers of a two-component epoxy paint primer, before applying the waterborne zwitterionic copolymer coating composition as outlined in Coating Preparation.

### Coating Preparation

Steel panels were prepared as illustrated in FIG. 1. Two coats of a two-component epoxy paint primer were brushed on the panel. The drying/overcoating timing was followed as described in the Interlux® VC Performance Epoxy and the Interprotect® 2000E technical data sheets for the commercial two-component epoxy paint primers used to evaluate the performance of the waterborne zwitterionic copolymer coating compositions. A third coat of this invention, a modified two-component epoxy paint primer containing a multi-functional epoxy additive, was applied and allowed to dry for 2 to 3 hours before the waterborne zwitterionic coating composition was applied as the topcoat on the panels. The coated panels were allowed to cure for 4 to 5 days at ambient temperature and humidity. The waterborne zwitterionic copolymer coating composition over the partially cured modified two-component epoxy paint primer containing a multi-functional epoxy is a coating system designed to provide antifouling properties while overcoming low adhesion strength and poor durability in a marine environment under static and dynamic water conditions that a boat would experience during normal operation. The fully cured waterborne zwitterionic copolymer coated panels were subjected to a shear test to determine its durability, an abrasion resistance test for adhesion and resistance to marring, and static antifouling tests in inter-coastal Florida waters.

### Preparation of Steel Panels

Steel panels were sanded with 80 grit paper on a palm sander, then wiped with methanol and acetone until no further grit or dirt was visible on the paper towel.

Epoxy paint primers were mixed according to the ratios in Table 3 and Table 4.

TABLE 3
Primer Compositions with Multi-Functional Epoxy Additive

| | Example 11 | Example 12 |
|---|---|---|
| Component | (g) | (g) |
| Interprotect ® 2000E epoxy base | 10 | — |
| Interprotect ® 2000E epoxy hardener | 2 | — |
| Interlux ® VC Performance epoxy base | — | 8.9 |
| Interlux ® VC Performance epoxy hardener | — | 6.1 |
| Ethylene glycol diglycidyl ether | 1.2 | 1.5 |

TABLE 4
Primer Compositions without Multi-Functional Epoxy Additive

| | Example 13 | Example 14 |
|---|---|---|
| Component | (g) | (g) |
| Interprotect ® 2000E epoxy base | 10 | — |
| Interprotect ® 2000E epoxy hardener | 2 | — |
| Interlux ® VC Performance epoxy base | — | 8.9 |
| Interlux ® VC Performance epoxy hardener | — | 6.1 |

Epoxy paint using the formulation in Table 3 was applied with a #60 Mayer rod to give a wet film thickness of ˜5 mils. The first layer was applied one day, and a second layer was applied the next day. The second coat of epoxy paint was allowed to cure overnight.

After the second layer of epoxy paint was cured, a third epoxy paint layer was applied containing ethylene glycol diglycidyl ether (Table 3) and allowed to dry for 2-3 hours at ambient conditions. To complete the coating preparation, the waterborne zwitterionic copolymer coating composition prepared in Examples of this invention 1 through 6 and the Comparative Example. All Examples were brushed over the modified epoxy paint primer layer containing the ethylene glycol diglycidyl ether additive.

Control coatings were prepared in the same manner except all three layers of epoxy paint were mixed according to the formulas in Table 4. Control coatings did not contain ethylene glycol diglycidyl ether in any of the epoxy paint primer layers.

The panels were allowed to cure at ambient conditions for 4-5 days.

### Shear Test

Applying shear to the coated panels will provide insight to the durability of the coatings before field testing. The shear bath consists of 1000 mL cylindrical beakers on a magnetic stir plate. Panels were clipped to the top rim of the beaker with binder clips, 800 mL of seawater was added, a 4 mm magnetic stir bar was added, and the stirring rate was set to 1000 rpm.

Panels were assessed periodically for changes in adhesion, thickness, and texture. The results showed that the durability and adhesion of the waterborne zwitterionic copolymer coating proved to have excellent adhesion over the modified two-component epoxy paint primer containing a multi-functional epoxy additive prepared based on Table 3, wherein the shear results are described in Table 5. Whereas the same waterborne zwitterionic copolymers had poor durability and adhesion over commercial two-component epoxy paint primer paint that did not contain the multi-functional epoxy additive. The Comparative waterborne zwitterionic copolymer without a monomer from Group C also exhibited poor durability when coated over commercial primer with or without the modified two-component epoxy paint primer containing a multi-functional epoxy additive present.

TABLE 5
Results from Shear Test

| | | Durability Performance |
|---|---|---|
| Description | Appearance | in Shear Bath |
| Examples 1, 2, 3, 4: | Hard, glossy | >6 weeks: Zwitterionic |
| Zwitterionic copolymer brushed | | copolymer was still on |
| over the epoxy paint in | | painted surface |
| Examples 11 and 12 | | |
| Examples 1, 2, 3, 4: | Hard, glossy | <2 days: Zwitterionic |
| Zwitterionic copolymer brushed | | copolymer eroded from |
| over the epoxy paint in | | the painted surface |
| Examples 13 and 14 | | |
| Comparative Example: | Hard, matte | <2 days: Comparative |
| Zwitterionic copolymer without | | Example eroded from |
| monomer from Group C brushed | | the painted surface |
| over the epoxy paint in | | |
| Examples 11, 12, 13, 14 | | |

### Abrasion Resistance Test

The abrasion test is designed to compare the wear rate and mass-loss of a material or coating. The coated panel is placed in constant contact with an abrasive material using a predetermined force to a specific cycle to evaluate the hydrophilic waterborne zwitterionic copolymer coating composition wear resistance and adhesion under simulated and accelerated wear conditions. Panels were assessed for abrasion and adhesion by “scrubbing” in the dry and hydrated states. More weight is given to the wet abrasion results, as the application of the antifouling coating composition is in an underwater fresh and saltwater environment.

The panels for Examples 1 through 6 were prepared as described in the section “Preparation of Steel Panels” using two layers of Interlux® VC Performance Epoxy and one layer of modified two-component epoxy paint primer containing a multi-functional epoxy additive.

Separately, to the waterborne zwitterionic copolymers of Example 1 and Example 3 was added 1% ethylene glycol diglycidyl ether, labeled as Examples 8 and 9.

Separately, to the waterborne zwitterionic copolymers in Example 2 and Example 4 were added 2% polyethylene glycol diglycidyl ether having a molecular formula of C₃H₅O₂—(C₂H₅O)ₙ—C₃H₅O, where n=500, labeled as Examples 10 and 11.

The panels for the waterborne zwitterionic coating compositions in Examples 8 through 11 were prepared as described in the section “Preparation of Steel Panels” using two layers of Interlux® VC Performance Epoxy and one layer of modified two-component epoxy paint primer containing a multi-functional epoxy additive.

For the dry panels, a Scotch Brite pad was affixed to a 16 oz hammer head. Panels were assessed for wear after 300 double rubs at intervals of 100 double rubs.

For the hydrated panels, a quadruple thick cheese cloth (folded over twice) was affixed to a 16 oz hammer head. Panels were assessed for wear after 300 double rubs at intervals of 100 double rubs.

The results of the test are summarized in Table 6 showing that the hydrophilic waterborne zwitterionic copolymer coating composition had good abrasion resistance and adhesion to the modified two-component epoxy paint primer containing a multi-functional epoxy additive over two layers of commercial two-component epoxy paint primer coating. The Comparative Example had poor abrasion resistance in both the dry and wet rub conditions. The scoring rubric used to rate the abrasion resistance is in Table 7.

TABLE 6
Results From Abrasion Resistance Test

| | 100 | 200 | 300 | 100 | 200 | 300 |
|---|---|---|---|---|---|---|
| Examples | Dry Double Rub Score | | | Wet Double Rub Score | | |
| Comparative | 1 | 2 | 3 | 6 | 7 | 7 |
| Example 1 | 1 | 1 | 1 | 1 | 2 | 2 |
| Example 2 | 1 | 1 | 1 | 1 | 2 | 2 |
| Example 3 | 1 | 1 | 1 | 0 | 0 | 0 |
| Example 4 | 1 | 1 | 1 | 0 | 0 | 0 |
| Example 5 | 0 | 0 | 1 | 0 | 1 | 2 |
| Example 6 | 1 | 2 | 2 | 0 | 0 | 0 |
| Example 8 | 1 | 1 | 1 | 1 | 1 | 1 |
| Example 9 | 1 | 1 | 2 | 1 | 1 | 1 |
| Example 10 | 0 | 0 | 1 | 0 | 0 | 0 |
| Example 11 | 1 | 1 | 2 | 1 | 1 | 1 |

TABLE 7
Rubric Used for Scoring Abrasion Resistant Test
Abrasion Resistant Scale

```
  0 = No marring
  1 = Very slight marring
  2 = Slight marring
  3 = Some marring
  4 = Heavy marring
  5 = Beginning of breakthrough
  6 = 25% breakthrough
  7 = 50% breakthrough
  8 = 75% breakthrough
  9 = 90% breakthrough
10 = Complete removal
```

### Static FL Field Tests

Static immersion testing exposes the coated panels to biofouling in a seawater environment. The static test was used to ascertain the relative antifouling performance of the hydrophilic waterborne zwitterionic copolymer coated composition. Static immersion tests were conducted in inter-coastal waterways having a salinity of about 10 parts per trillion with an average water temperature of 89° F. in the summer months and an average water temperature of 81° F. in the winter months.

The panels were prepared as described in the section “Preparation of Steel Panels” using two layers of Interlux® VC Performance Epoxy and one layer of modified two-component epoxy paint primer containing a multi-functional epoxy additive. Prior to applying the copolymer topcoat, 1% ethylene glycol diglycidyl ether was mixed into the waterborne zwitterionic copolymer composition as described in Example 1.

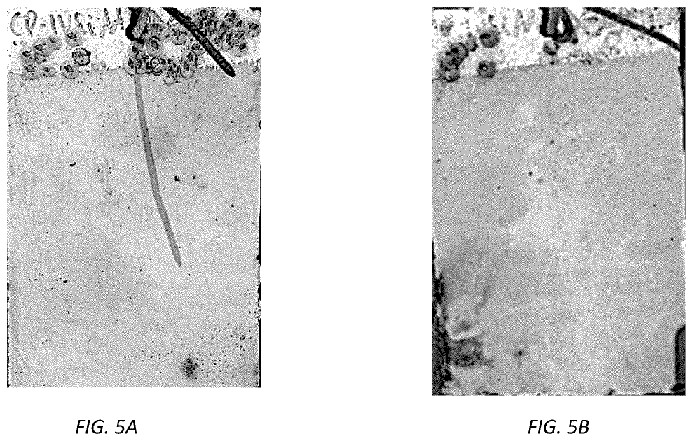

FIGS. 5A and 5B show panels having coating of the present invention showing clean non-fouled surfaces. Specifically, FIG. 5A illustrates a panel having a zwitterionic copolymer coating composition, as described herein, after 5 months static immersion in Florida waters. FIG. 5A illustrates a zwitterionic copolymer coating composition, as described herein, after 8 months static immersion in Florida waters. The pictures do show barnacle fouling that are attached on the top portion of the panel, which shows exposed paint primer coating surface that is not covered with the waterborne zwitterionic copolymer coating composition.

While the disclosed materials have been described in detail in connection with only a limited number of embodiments, it should be readily understood that the embodiments are not limited to such disclosed embodiments. Rather, that disclosed can be modified to incorporate any number of variations, alterations, substitutions, or equivalent arrangements not heretofore described, but which are commensurate with the spirit and scope of the disclosed materials. Additionally, while various embodiments have been described, it is to be understood that disclosed aspects may include only some of the described embodiments.

We claim:

1. A marine coating composition comprising:
a substrate coated with a first paint primer layer; and
a second layer over the first layer, wherein the second layer comprises a first multi-functional epoxy additive; and
a waterborne zwitterionic copolymer coating composition over the second layer, wherein the copolymer coating composition comprises a zwitterionic component, an anionic component, and a reactive component, wherein the zwitterionic component comprises repeating units derived from zwitterionic monomers, wherein the anionic component comprises repeating units derived from anionic monomers, and wherein the reactive component comprises repeating units derived from hydroxyl or amine functional monomers.

2. The composition of claim 1, wherein copolymer coating composition comprises from about 25 to about 90% by weight zwitterionic moieties, from about 5 to about 70% by weight anionic moieties, and from about 2 to about 50% by weight reactive moieties.

3. The composition of claim 1, wherein the copolymer coating composition comprises from about 50 to about 62% by weight zwitterionic moieties, from about 18 to about 40% by weight anionic moieties, and from about 10 to about 20% by weight reactive moieties.

4. The composition of claim 1, wherein the copolymer coating composition is derived from carboxybetaine methacrylamide, acrylic acid, and hydroxyethyl methacrylate monomers.

5. The composition of claim 1, wherein the copolymer coating composition is derived from carboxybetaine methacrylamide, acrylic acid, and dimethylaminopropyl methacrylamide monomers.

6. The composition of claim 1, wherein the copolymer coating composition comprises less than 5% by weight methylene bis-acrylamide.

7. The composition of claim 1, wherein the substrate is coated with two layers of a two-component epoxy paint primer and a third layer of a two-component epoxy paint primer comprising a first multi-functional epoxy additive.

8. The composition of claim 1, wherein the first multi-functional epoxy additive is present from about 5 to about 15% by weight.

9. The composition of claim 1, wherein the first multi-functional epoxy additive is ethylene glycol diglycidyl ether.

10. The composition of claim 1, wherein the copolymer coating composition comprises a second multi-functional epoxy additive from about 0.5 to about 5% by weight.

11. The composition of claim 1, wherein the copolymer coating composition comprises ethylene glycol diglycidyl ether.

12. The composition of claim 1, wherein the copolymer coating composition comprises polyethylene glycol diglycidyl ether having a molecular formula of C₃H₅O₂(C₂H₅O)ₙ—C₃H₅O where n is an integer from 200 to 1000.

13. The composition of claim 1, wherein the copolymer coating composition comprises about 0.5 to about 2% by weight humectant.

14. The composition of claim 1, wherein the copolymer coating composition comprises a 1 to 5% by weight wetting agent.

15. A zwitterionic copolymer composition comprising:
from about 25 to about 90% by weight zwitterionic moieties;
from about 5 to about 70% by weight anionic moieties; and
from about 2 to about 50% by weight reactive moieties.

16. A method of coating a substrate comprising:
coating a substrate with a paint primer layer; and
applying a second layer over the first layer, wherein the second layer comprises a multi-functional epoxy additive; and
applying a waterborne zwitterionic copolymer coating composition over the second layer and allowing the copolymer coating composition to cure to a dry film, wherein the copolymer coating composition comprises a zwitterionic component, an anionic component, and a reactive component, wherein the zwitterionic component comprises repeating units derived from zwitterionic monomers, and wherein the anionic component comprises repeating units derived from anionic monomers, and wherein the reactive component comprises repeating units derived from hydroxyl or amine functional monomers.

17. The method of coating a substrate according to claim 16, wherein the substrate is additionally coated with a first layer comprising a first epoxy paint primer and a second layer comprising a second epoxy paint primer.

18. The method of coating a substrate according to claim 17, wherein a third primer layer is applied over the two layers of the epoxy paint primer, wherein the third layer comprises a third epoxy paint primer comprising a multi-functional epoxy additive.

19. The method of coating a substrate according to claim 16, wherein the waterborne zwitterionic copolymer coating composition contains a multi-functional epoxy additive from about 0.5 to about 5% by weight.

20. The method of coating a substrate according to claim 16 wherein the substrate is configured to be used underwater in a marine environment.
